(19) United States
(12) Patent Application Publication
(10) Pub. No.: US 2022/0039131 A1
(43) Pub. Date: Feb. 3, 2022

(54) TERMINAL APPARATUS, BASE STATION APPARATUS, AND COMMUNICATION METHOD

(71) Applicants: Sharp Kabushiki Kaisha, Sakai City, Osaka (JP); FG Innovation Company Limited, Tuen Mun, New Territories (HK)

(72) Inventors: Huifa LIN, Sakai City (JP); Shoichi SUZUKI, Sakai City (JP); Daiichiro NAKASHIMA, Sakai City (JP); Toshizo NOGAMI, Sakai City (JP); Wataru OUCHI, Sakai City (JP); Tomoki YOSHIMURA, Sakai City (JP); Taewoo LEE, Sakai City (JP)

(21) Appl. No.: 17/298,962

(22) PCT Filed: Dec. 2, 2019
(86) PCT No.: PCT/JP2019/047052

§ 371 Date: Jun. 2, 2021

(30) Foreign Application Priority Data
Dec. 18, 2018 (JP) 2018-236425

(51) Int. Cl. H04W 72/12; H04L 1/18; H04L 5/00; H04W 72/04

(52) U.S. Cl. CPC H04W 72/1273; H04L 1/1819; H04W 72/0453; H04W 72/042; H04W 72/0446; H04L 5/0053

(57) ABSTRACT

It is possible to efficiently perform uplink transmission. A terminal apparatus includes a receiver configured to receive a PDCCH and receive a PDSCH scheduled based at least on the PDCCH, in which either a first generation method or a second generation method is selected as a method for generating a HARQ-ACK codebook, in the HARQ-ACK codebook, as the first generation method, a HARQ-ACK information bit is set to an NACK, the HARQ-ACK information bit corresponding to a PDSCH that is not associated with the HARQ-ACK codebook according to a HARQ-ACK timing based on the certain information, and the second generation method is different from the first generation method.

### TECHNICAL FIELD

The present invention relates to a terminal apparatus, a base station apparatus, and a communication method. This application claims priority based on JP 2018-236425 filed on Dec. 18, 2018, the contents of which are incorporated herein by reference.

### BACKGROUND ART

In the 3^{rd} Generation Partnership Project (3GPP), a radio access method and a radio network for cellular mobile communications (hereinafter referred to as “Long Term Evolution (LTE)” or “Evolved Universal Terrestrial Radio Access (EUTRA)”) have been studied. In LTE, a base station apparatus is also referred to as an evolved NodeB (eNodeB), and a terminal apparatus is also referred to as User Equipment (UE). LTE is a cellular communication system in which a plurality of areas covered by a base station apparatus are distributed in a cell structure. A single base station apparatus may manage a plurality of serving cells.

3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is required to satisfy requirements for three use cases including enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, 7th to 10th March, 2016.

### SUMMARY OF INVENTION

### Technical Problem

One aspect of the present invention provides a terminal apparatus that efficiently performs communication, a communication method used for the terminal apparatus, a base station apparatus that efficiently performs communication, and a communication method used for the base station apparatus.

### Solution to Problem

(1) According to a first aspect of the present invention, there is provided a terminal apparatus including a receiver configured to receive a PDCCH and receive a PDSCH scheduled based at least on the PDCCH, in which either a first generation method or a second generation method is selected as a method for generating a HARQ-ACK codebook, in the HARQ-ACK codebook, as the first generation method, a HARQ-ACK information bit is set to an NACK, the HARQ-ACK information bit corresponding to a PDSCH that is not associated with the HARQ-ACK codebook according to a HARQ-ACK timing based on the certain information, and the second generation method is different from the first generation method.

(2) According to a second aspect of the present invention, there is provided a base station apparatus including a transmitter configured to transmit a PDCCH and transmit a PDSCH scheduled based at least on the PDCCH, and a receiver configured to select either a first reception processing method or a second reception processing method as a method for receiving a HARQ-ACK codebook and receive the HARQ-ACK codebook including HARQ-ACK information corresponding to the PDSCH via a PUCCH or a PUSCH based on a timing indicated by a value set to certain information, in which the HARQ-ACK codebook is a sequence of HARQ-ACK information bits corresponding to one or a plurality of the PDSCHs, in the HARQ-ACK codebook, as the first reception processing method, a HARQ-ACK information bit is set to an NACK, the HARQ-ACK information bit corresponding to a PDSCH that is not associated with the HARQ-ACK codebook according to a HARQ-ACK timing based on the certain information, and, in the HARQ-ACK codebook, as the second reception processing method, a part or an entirety of a plurality of the HARQ-ACK information bits are set as valid HARQ-ACK information, the plurality of the HARQ-ACK information bits corresponding to the PDSCH that is not associated with the HARQ-ACK codebook according to the HARQ-ACK timing based on the certain information.

(3) According to a third aspect of the present invention, there is provided a communication method used by a terminal apparatus, the method including the steps of receiving a PDCCH and receiving a PDSCH scheduled based at least on the PDCCH, selecting either a first generation method or a second generation method as a method for generating a HARQ-ACK codebook, reporting (transmitting) the HARQ-ACK codebook including HARQ-ACK information corresponding to the PDSCH via a PUCCH or a PUSCH based on a timing indicated by a value set to certain information, the HARQ-ACK codebook being a sequence of HARQ-ACK information bits corresponding to one or a plurality of the PDSCHs, determining the HARQ-ACK codebook including at least a HARQ-ACK information bit corresponding to the PDSCH, setting, in the HARQ-ACK codebook, as the first generation method, a HARQ-ACK information bit to an NACK, the HARQ-ACK information bit corresponding to a PDSCH that is not associated with the HARQ-ACK codebook according to a HARQ-ACK timing based on the certain information, and setting, in the HARQ-ACK codebook, as the second generation method, a part or an entirety of a plurality of the HARQ-ACK information bits as valid HARQ-ACK information, the plurality of the HARQ-ACK information bits corresponding to the PDSCH that is not associated with the HARQ-ACK codebook according to the HARQ-ACK timing based on the certain information.

(4) According to a fourth aspect of the present invention, there is provided a communication method used by a base station apparatus, the method including the steps of transmitting a PDCCH and transmitting a PDSCH scheduled based at least on the PDCCH, selecting either a first reception processing method or a second reception processing method as a method for receiving a HARQ-ACK codebook, receiving the HARQ-ACK codebook including HARQ-ACK information corresponding to the PDSCH via a PUCCH or a PUSCH based on a timing indicated by a value set to certain information, the HARQ-ACK codebook being a sequence of HARQ-ACK information bits corresponding to one or a plurality of the PDSCHs, setting, in the HARQ-ACK codebook, as the first reception processing method, a HARQ-ACK information bit to an NACK, the HARQ-ACK information bit corresponding to a PDSCH that is not associated with the HARQ-ACK codebook according to a HARQ-ACK timing based on the certain information, and setting, in the HARQ-ACK codebook, as the second reception processing method, a part or an entirety of a plurality of the HARQ-ACK information bits as valid HARQ-ACK information, the plurality of the HARQ-ACK information bits corresponding to the PDSCH that is not associated with the HARQ-ACK codebook according to the HARQ-ACK timing based on the certain information.

### Advantageous Effects of Invention

According to one aspect of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship of N^{slot}_{symb}, a subcarrier spacing configuration μ, a slot configuration, and a CP configuration according to an aspect of the present embodiment.

FIG. 3 is a schematic diagram illustrating an example of a resource grid in a subframe according to an aspect of the present embodiment.

FIG. 4 is a schematic block diagram illustrating structure of a terminal apparatus 1 according to an aspect of the present embodiment.

FIG. 5 is a schematic block diagram illustrating structure of a base station apparatus 3 according to an aspect of the present embodiment.

FIG. 6 is a diagram illustrating a procedure for determining a set of M_{A, c} occasions for candidate PDSCH receptions according to an aspect of the present embodiment.

FIG. 7 is a diagram illustrating a procedure in which a terminal apparatus 1 determines a HARQ-ACK information bit of a transmitted HARQ-ACK codebook according to an aspect of the present embodiment.

FIG. 8 is a diagram illustrating a method in which the terminal apparatus 1 determines a HARQ-ACK information bit of the transmitted HARQ-ACK codebook according to an aspect of the present embodiment.

### DESCRIPTION OF EMBODIMENTS

Embodiments of the present invention will be described below.

The fact that a parameter or information indicates one or a plurality of values may mean that the parameter or the information includes at least a parameter or information indicating the one or the plurality of values. A higher layer parameter may be a single higher layer parameter. The higher layer parameter may be an Information Element (IE) including a plurality of parameters.

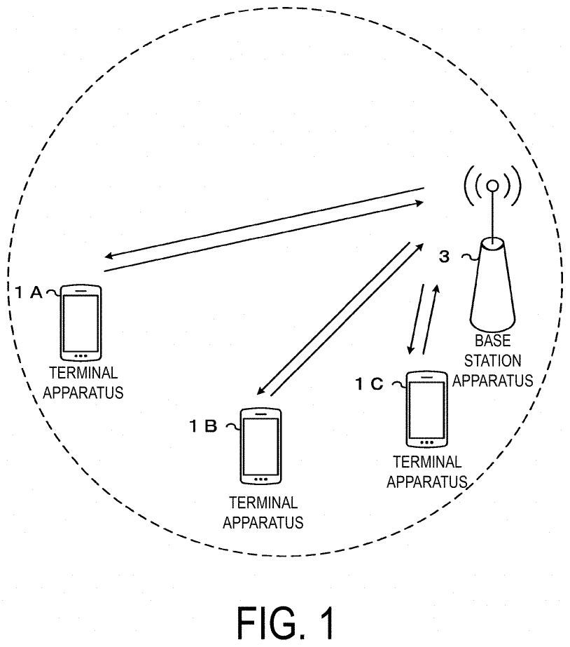

FIG. 1 is a conceptual diagram of a radio communication system according to an aspect of the present embodiment. In FIG. 1, the radio communication system includes terminal apparatuses 1A to 1C and a base station apparatus 3. Hereinafter, each of the terminal apparatuses 1A to 1C is also referred to as a terminal apparatus 1.

The base station apparatus 3 may be configured to include one of or both a Master Cell Group (MCG) and a Secondary Cell Group (SCG). The MCG is a group of serving cells configured to include at least a Primary Cell (PCell). The SCG is a group of serving cells configured to include at least a Primary Secondary Cell (PSCell). The PCell may be a serving cell provided based on an initial connection. The MCG may be configured to include one or a plurality of Secondary Cells (SCells). The SCG may be configured to include one or a plurality of SCells. A serving cell identity is a short identity for identifying the serving cell. The serving cell identity may be provided by a higher layer parameter.

Hereinafter, a frame structure will be described.

In the radio communication system according to an aspect of the present embodiment, at least Orthogonal Frequency Division Multiplex (OFDM) is used. The OFDM symbol is a unit of a time domain of the OFDM. The OFDM symbol includes at least one or a plurality of subcarriers. The OFDM symbol may be converted into a time-continuous signal in baseband signal generation.

A SubCarrier Spacing (SCS) may be provided as a subcarrier spacing Δf=2μ·15 kHz. For example, a subcarrier spacing configuration μ may be configured to be any of 0, 1, 2, 3, 4, and/or 5. For a certain BandWidth Part (BWP), the subcarrier spacing configuration μ may be provided by a higher layer parameter.

In the radio communication system according to an aspect of the present embodiment, a time unit T_{c} is used for representing a length of the time domain. The time unit T_{c} may be provided as T_{c}=1/(Δfₘₐₓ·N_{f}). Δfₘₐₓ may be the maximum value of the subcarrier spacing supported by the radio communication system according to an aspect of the present embodiment. Δfₘₐₓ may satisfy Δfₘₐₓ=480 kHz. N_{f} may satisfy N_{f}=4096. A constant κ satisfies κ=Δfₘₐₓ·N_{f}/(Δf_{ref}N_{f, ref})=64. Δf_{ref} may be 15 kHz. N_{f, ref} may be 2048.

The constant κ may be a value indicating a relationship between a reference subcarrier spacing and T_{c}. The constant κ may be used for a length of a subframe. The number of slots included in the subframe may be provided based at least on the constant κ. Δf_{ref} is the reference subcarrier spacing, and N_{f, ref} is a value corresponding to the reference subcarrier spacing.

Downlink transmission and/or uplink transmission includes frames of 10 ms. A frame is configured to include 10 subframes. A length of a subframe is 1 ms. The length of the frame may be provided regardless of the subcarrier spacing Δf. In other words, the frame configuration may be provided regardless of μ. The length of the subframe may be provided regardless of the subcarrier spacing Δf. In other words, the configuration of the subframe may be provided regardless of μ.

For a certain subcarrier spacing configuration μ, the number and indexes of slots included in a subframe may be provided. For example, a first slot number n^{μ}ₛ may be provided in ascending order ranging from 0 to N^{subframe, μ}ₛₗₒₜ−1 within a subframe. For the subcarrier spacing configuration μ, the number and indexes of slots included in a frame may be provided. For example, a second slot number n^{μ}_{s, f} may be provided in ascending order ranging from 0 to N^{frame, μ}ₛₗₒₜ−1 within a frame. N^{slot}_{symb} continuous OFDM symbols may be included in one slot. N^{slot}_{symb} may be provided based at least on a part or an entirety of a slot configuration and/or a Cyclic Prefix (CP) configuration. The slot configuration may be provided at least by a higher layer parameter tdd-UL-DL-ConfigurationCommon. The CP configuration may be provided based at least on a higher layer parameter. The CP configuration may be provided based at least on dedicated RRC signaling. Each of the first slot number and the second slot number is also referred to as slot number (slot index).

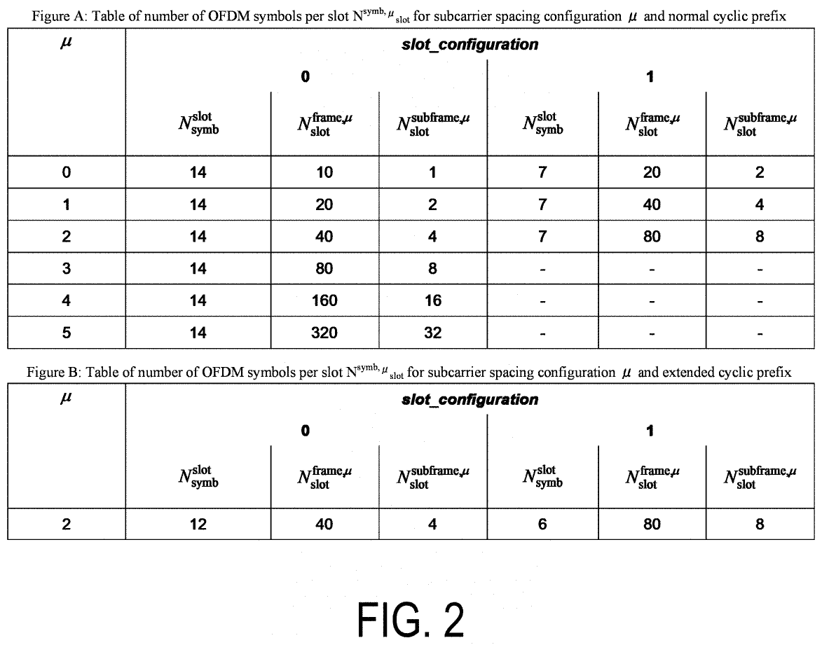

FIG. 2 is an example illustrating a relationship of N^{slot}_{symb}, a subcarrier spacing configuration μ, a slot configuration, and a CP configuration according to an aspect of the present embodiment. In FIG. 2A, in a case that the slot configuration is zero, the subcarrier spacing configuration μ is two, and the CP configuration is a normal cyclic prefix (normal CP), N^{slot}_{symb}=14, N^{frame, μ}ₛₗₒₜ=40, and N^{subframe, μ}ₛₗₒₜ=4. In addition, in FIG. 2B, in a case that the slot configuration is zero, the subcarrier spacing configuration μ is two, and the CP configuration is an extended cyclic prefix (extended CP), N^{slot}_{symb}=12, N^{frame, μ}ₛₗₒₜ=40, and N^{subframe, μ}ₛₗₒₜ=4. The value of N^{slot}_{symb} in the slot configuration 0 may corresponds to twice the value of N^{slot}_{symb} in the slot configuration 1.

Physical resources will be described below.

An antenna port is defined in such a manner that a channel through which a symbol is transmitted at one antenna port can be estimated from a channel through which another symbol is transmitted at the same antenna port. In a case that a large scale property of a channel through which a symbol is transmitted at one antenna port can be estimated from a channel through which a symbol is transmitted at another antenna port, the two antenna ports are referred to as Quasi Co-Located (QCL). The large scale properties may include at least a long term performance of a channel. The large scale properties may include at least some or all of delay spread, Doppler spread, Doppler shift, an average gain, an average delay, and beam parameters (spatial Rx parameters). The fact that a first antenna port and a second antenna port are QCL with respect to a beam parameter may mean that a reception beam assumed by the reception side for the first antenna port is the same as a reception beam assumed by the reception side for the second antenna port. The fact that the first antenna port and the second antenna port are QCL with respect to a beam parameter may mean that a transmission beam assumed by the reception side for the first antenna port is the same as a transmission beam assumed by the reception side for the second antenna port. In a case that a large scale property of a channel through which a symbol is transmitted at one antenna port can be estimated from a channel through which a symbol is transmitted at another antenna port, the two antenna ports may be assumed to be QCL in the terminal apparatus 1. The fact that the two antenna ports are QCL may mean that the two antenna ports are assumed to be QCL.

For each set of a subcarrier spacing configuration and a carrier, a resource grid including N^{μ}_{RB, x}N^{RB}_{sc} subcarriers and N^{(μ)}_{symb}N^{subframe, μ}_{symb} OFDM symbols is provided. N^{μ}_{RB, x} may indicate the number of resource blocks provided for the subcarrier spacing configuration μ for a carrier x. N^{μ}_{RB, x} may indicate the maximum number of resource blocks provided for the subcarrier spacing configuration μ for the carrier x. The carrier x indicates either a downlink carrier or an uplink carrier. In other words, x is “DL” or “UL”. N^{μ}_{RB} is a name including N^{μ}_{RB, DL} and/or N^{μ}_{RB, UL}. N^{RB}_{sc} may indicate the number of subcarriers included in one resource block. At least one resource grid may be provided for each antenna port p and/or for each subcarrier spacing configuration μ and/or for each Transmission direction configuration. The transmission direction includes at least DownLink (DL) and UpLink (UL). Hereinafter, a set of parameters including at least some or all of the antenna port p, the subcarrier spacing configuration μ, and the transmission direction configuration is also referred to as a first radio parameter set. In other words, one resource grid may be provided for each first radio parameter set.

A carrier included in a serving cell in downlink is referred to as a downlink carrier (or a downlink component carrier). A carrier included in a serving cell in uplink is referred to as an uplink carrier (uplink component carrier). A downlink component carrier and an uplink component carrier are collectively referred to as a component carrier (or a carrier).

Each element in the resource grid provided for each first radio parameter set is referred to as a resource element. The resource element is identified by an index k_{sc} of the frequency domain and an index l_{sym} of the time domain. The resource element is identified by an index k_{sc} of the frequency domain and an index l_{sym} of the time domain for a certain first radio parameter set. The resource element to be identified by the index k_{sc} of the frequency domain and the index l_{sym} of the time domain is also referred to as a resource element (k_{sc}, l_{sym}). The index k_{sc} of the frequency domain indicates any value from 0 to N^{μ}_{RB}N^{RB}_{sc}−1. N_{RB} may be the number of resource blocks provided for the subcarrier spacing configuration μ. N^{RB}_{sc} is the number of subcarriers included in a resource block, and N^{RB}_{sc}=12. The index k_{sc} of the frequency domain may correspond to a subcarrier index k_{sc}. The index l_{sym} of the time domain may correspond to an OFDM symbol index l_{sym}.

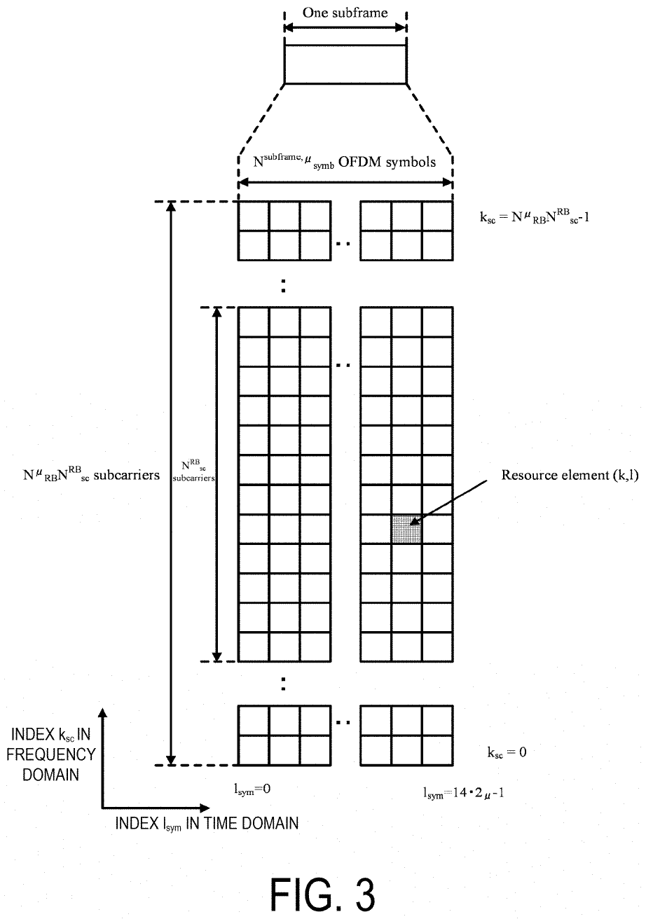

FIG. 3 is a schematic diagram illustrating an example of a resource grid in a subframe according to an aspect of the present embodiment. In the resource grid in FIG. 3, the horizontal axis is the index l_{sym} of the time domain, and the vertical axis is the index k_{sc} of the frequency domain. In one subframe, the frequency domain of the resource grid includes N^{μ}_{RB}N^{RB}_{sc} subcarriers. In one subframe, the time domain of the resource grid may include 14·2μ OFDM symbols. One resource block is configured to include N^{RB}_{sc} subcarriers. The time domain of the resource block may correspond to one OFDM symbol. The time domain of the resource block may correspond to 14 OFDM symbols. The time domain of the resource block may correspond to one or a plurality of slots. The time domain of the resource block may correspond to one subframe.

The terminal apparatus 1 may receive an indication of transmission and/or reception using only a subset of resource grids. The subset of resource grids is also referred to as a BWP, and the BWP may be provided based at least on a part or an entirety of the higher layer parameter and/or DCI. The BWP is also referred to as a bandwidth part (BP). In other words, the terminal apparatus 1 may not receive an indication of transmission and/or reception using all sets of resource grids. In other words, the terminal apparatus 1 may receive an indication of transmission and/or reception using some frequency resources within the resource grid. One BWP may include a plurality of resource blocks in the frequency domain. One BWP may include a plurality of resource blocks that are continuous in the frequency domain. A BWP configured for a downlink carrier is also referred to as a downlink BWP. A BWP configured for an uplink carrier is also referred to as an uplink BWP.

One or a plurality of downlink BWPs may be configured for the terminal apparatus 1. The terminal apparatus 1 may attempt to receive a physical channel (for example, a PDCCH, a PDSCH, and/or an SS/PBCH) in one downlink BWP out of the one or plurality of downlink BWPs. The one downlink BWP is also referred to as an active downlink BWP.

One or a plurality of uplink BWPs may be configured for the terminal apparatus 1. The terminal apparatus 1 may attempt to transmit a physical channel (for example, a PUCCH, a PUSCH, and/or a PRACH) in one uplink BWP out of the one or plurality of uplink BWPs. The one uplink BWP is also referred to as an active uplink BWP.

A set of downlink BWPs may be configured for each serving cell. The set of downlink BWPs may include one or a plurality of downlink BWPs. A set of uplink BWPs may be configured for each serving cell. The set of uplink BWPs may include one or a plurality of uplink BWPs.

A higher layer parameter is a parameter included in a higher layer signaling. The higher layer signaling may be Radio Resource Control (RRC) signaling or a Medium Access Control (MAC) Control Element (CE). Here, the higher layer signaling may be an RRC layer signal or an MAC layer signal.

The higher layer signaling may be common RRC signaling. The common RRC signaling may include at least some or all of the following features C1 to C3. Feature C1) to be mapped to a BCCH logical channel or a CCCH logical channel, or

Feature C2) to include at least a radioResourceConfigCommon information element, or

Feature C3) to be mapped to a PBCH.

The radioResourceConfigCommon information element may include information indicating a configuration commonly used in a serving cell. The configuration commonly used in a serving cell may include at least a PRACH configuration. The PRACH configuration may indicate at least one or a plurality of random access preamble indexes. The PRACH configuration may indicate at least a time/frequency resource of the PRACH.

The higher layer signaling may be dedicated RRC signaling. The dedicated RRC signaling may include at least some or all of the following features D1 and D2.

Feature D1) to be mapped to a DCCH logical channel, or

Feature D2) to include at least a radioResourceConfigDedicated information element.

The radioResourceConfigDedicated information element may include at least information indicating a configuration specific to the terminal apparatus 1. The radioResourceConfigDedicated information element may include at least information indicating a BWP configuration. The BWP configuration may indicate at least a frequency resource of the BWP.

For example, a MIB, first system information, and second system information may be included in the common RRC signaling. In addition, a higher layer message that is mapped to the DCCH logical channel and includes at least radioResourceConfigCommon may be included in the common RRC signaling. In addition, a higher layer message that is mapped to the DCCH logical channel and does not include the radioResourceConfigCommon information element may be included in the dedicated RRC signaling. In addition, a higher layer message that is mapped to the DCCH logical channel and includes at least the radioResourceConfigDedicated information element may be included in the dedicated RRC signaling.

The first system information may indicate at least a time index of a Synchronization Signal (SS) block. The SS block is also referred to as an SS/PBCH block. The SS/PBCH block is also referred to as an SS/PBCH. The first system information may include at least information related to a PRACH resource. The first system information may include at least information related to a configuration of initial connection. The second system information may be system information other than the first system information.

The radioResourceConfigDedicated information element may include at least information related to a PRACH resource. The radioResourceConfigDedicated information element may include at least information related to the configuration of initial connection.

A physical channel and physical signal according to various aspects of the present embodiment will be described below.

An uplink physical channel may correspond to a set of resource elements that convey information generated in a higher layer. The uplink physical channel is a physical channel used in uplink carrier. In the radio communication system according to an aspect of the present embodiment, at least some or all of the uplink physical channels described below are used.
Physical Uplink Control CHannel (PUCCH)
Physical Uplink Shared CHannel (PUSCH)
Physical Random Access CHannel (PRACH)

The PUCCH may be used to transmit Uplink Control Information (UCI). The uplink control information includes some or all of Channel State Information (CSI), a Scheduling Request (SR), and a Hybrid Automatic Repeat request ACKnowledgement (HARQ-ACK) corresponding to a transport block (TB, a Medium Access Control Protocol Data Unit (MAC PDU), Downlink-Shared Channel (DL-SCH), and/or a Physical Downlink Shared Channel (PDSCH)).

The HARQ-ACK may include at least a HARQ-ACK bit corresponding at least to one transport block. The HARQ-ACK bit may indicate an acknowledgement (ACK) or a negative-acknowledgement (NACK) corresponding to one or a plurality of transport blocks. The HARQ-ACK may include at least a HARQ-ACK codebook including one or a plurality of HARQ-ACK bits. The fact that the HARQ-ACK bit corresponds to one or a plurality of transport blocks may mean that the HARQ-ACK bit corresponds to a PDSCH including the one or the plurality of transport blocks.

The HARQ-ACK bit may indicate an ACK or NACK corresponding to one Code Block Group (CBG) included in the transport block. The HARQ-ACK is also referred to as HARQ feedback, HARQ information, or HARQ control information.

The Scheduling Request (SR) may be used at least for requesting a resource of a PUSCH for initial transmission. A scheduling request bit may be used to indicate either a positive SR or a negative SR. The scheduling request bit indicating the positive SR is also referred to as “the positive SR being transmitted”. The positive SR may indicate that a resource of the PUSCH for initial transmission is requested by the terminal apparatus 1. The positive SR may indicate that a scheduling request is triggered by the higher layer. The positive SR may be transmitted in a case that the higher layer indicates transmission of the scheduling request. The scheduling request bit indicating the negative SR is also referred to as “the negative SR being transmitted”. The negative SR may indicate that the resource of the PUSCH for initial transmission is not requested by the terminal apparatus 1. The negative SR may indicate that the scheduling request is not triggered by the higher layer. The negative SR may be transmitted in a case that transmission of a scheduling request is not indicated by the higher layer.

Channel state information may include at least some or all of a Channel Quality Indicator (CQI), a Precoder Matrix Indicator (PMI), and a Rank Indicator (RI). The CQI is an indicator related to channel quality (for example, propagation intensity), and the PMI is an indicator that indicates a precoder. The RI is an indicator indicating a transmission rank (or the number of transmission layers).

The PUCCH supports PUCCH formats (PUCCH formats 0 to 4). The PUCCH formats may be mapped to the PUCCH and may then be transmitted. The PUCCH format may be transmitted through the PUCCH. The fact that the PUCCH format is transmitted may mean that the PUCCH is transmitted.

The PUSCH may be used at least to transmit a transport block ((TB), the MAC PDU, a UL-SCH, and/or the PUSCH). The PUSCH may be used to transmit at least some or all of the transport block, the HARQ-ACK, the channel state information, and the scheduling request. The PUSCH is used at least to transmit a random access message 3.

The PRACH is used at least to transmit a random access preamble (random access message 1). The PRACH may be used at least to indicate some or all of an initial connection establishment procedure, a handover procedure, a connection re-establishment procedure, synchronization for PUSCH transmission (timing adjustment), and a resource request for the PUSCH. The random access preamble may be used to notify the base station apparatus 3 of an index (random access preamble index) provided by a higher layer of the terminal apparatus 1.

In FIG. 1, the following uplink physical signals are used for uplink radio communication. The uplink physical signals may not be used to transmit information output from a higher layer, but is used by a physical layer.
UpLink Demodulation Reference Signal (UL DMRS)
Sounding Reference Signal (SRS)
UpLink Phase Tracking Reference Signal (UL PTRS)

The UL DMRS is associated with transmission of the PUSCH and/or the PUCCH. The UL DMRS is multiplexed with the PUSCH or the PUCCH. The base station apparatus 3 may use the UL DMRS in order to perform channel compensation of the PUSCH or the PUCCH. Hereinafter, transmission of both a PUSCH and a UL DMRS associated with the PUSCH will be simply referred to as transmission of a PUSCH. Hereinafter, transmission of both a PUCCH and a UL DMRS associated with the PUCCH will be simply referred to as transmission of a PUCCH. The UL DMRS associated with the PUSCH is also referred to as a UL DMRS for a PUSCH. The UL DMRS associated with the PUCCH is also referred to as a UL DMRS for a PUCCH.

The SRS may not be associated with transmission of the PUSCH or the PUCCH. The base station apparatus 3 may use the SRS for measuring a channel state. The SRS may be transmitted at the end of a subframe in an uplink slot or at a prescribed number of OFDM symbols from the end.

The UL PTRS may be a reference signal that is used at least for phase tracking. The UL PTRS may be associated with a UL DMRS group including at least an antenna port used for one or a plurality of UL DMRSs. The fact that the UL PTRS associates with the UL DMRS group may mean that at least the antenna port for the UL PTRS and some or all of the antenna ports included in the UL DMRS group are QCL. The UL DMRS group may be identified based at least on the antenna port of the lowest index for the UL DMRS included in the UL DMRS group. The UL PTRS may be mapped to the antenna port of the smallest index from among one or more antenna ports to which one codeword is mapped. The UL PTRS may be mapped to a first layer in a case that one codeword is mapped at least to the first layer and a second layer. The UL PTRS may not be mapped to the second layer. The index of the antenna port to which the UL PTRS is mapped may be provided based at least on the downlink control information.

In FIG. 1, the following downlink physical channels are used for downlink radio communication from the base station apparatus 3 to the terminal apparatus 1. The downlink physical channels are used by the physical layer for transmission of information output from a higher layer.
Physical Broadcast Channel (PBCH)
Physical Downlink Control Channel (PDCCH)
Physical Downlink Shared Channel (PDSCH)

The PBCH is used at least to transmit a Master Information Block ((MIB), and/or a Broadcast Channel (BCH)). The PBCH may be transmitted based on a prescribed transmission interval. The PBCH may be transmitted at an interval of 80 ms. The PBCH may be transmitted at an interval of 160 ms. Contents of information included in the PBCH may be updated at every 80 ms. A part or an entirety of the information included in the PBCH may be updated at every 160 ms. The PBCH may include 288 subcarriers. The PBCH may be configured to include two, three, or four OFDM symbols. The MIB may include information associated with an identity (index) of a synchronization signal. The MIB may include information indicating at least some of a slot number, a subframe number, and/or a radio frame number in which a PBCH is transmitted.

The PDCCH is used at least to transmit Downlink Control Information (DCI). The PDCCH may be transmitted with at least the downlink control information included therein. The PDCCH may include the downlink control information. The downlink control information is also referred to as a DCI format. The downlink control information may include at least either a downlink grant or an uplink grant. The DCI format used for scheduling the PDSCH is also referred to as a downlink DCI format. The DCI format used for scheduling the PUSCH is also referred to as an uplink DCI format. The downlink grant is also referred to as downlink assignment or downlink allocation. The uplink DCI format includes at least one of or both a DCI format 0_0 and a DCI format 0_1.

The DCI format 0_0 is configured to include at least some or all of 1A to 1F.

1A) DCI format specification field (Identifier for DCI formats field)

1B) Frequency domain resource assignment field

1C) Time domain resource assignment field

1D) Frequency hopping flag field

1E) Modulation and Coding Scheme field (MCS field)

1F) First CSI request field

The DCI format specification field may be used at least to indicate which of one or a plurality of DCI formats the DCI format including the DCI format specification field corresponds to. The one or plurality of DCI formats may be provided based at least on some or all of a DCI format 1_0, a DCI format 1_1, the DCI format 0_0, and/or the DCI format 0_1.

The frequency domain resource assignment field may be used at least to indicate assignment of a frequency resource for the PUSCH scheduled by the DCI format including the frequency domain resource assignment field. The frequency domain resource assignment field is also referred to as Frequency Domain Resource Allocation (FDRA) field.

The time domain resource assignment field may be used at least to indicate assignment of a time resource for the PUSCH scheduled by the DCI format including the time domain resource assignment field.

The frequency hopping flag field may be used at least to indicate whether frequency hopping is to be applied to the PUSCH scheduled by the DCI format including the frequency hopping flag field.

The MCS field may be used at least to indicate some or all of a modulation scheme for the PUSCH scheduled by the DCI format including the MCS field and/or a target coding rate. The target coding rate may be a target coding rate for a transport block of the PUSCH. The size of the transport block (Transport Block Size (TBS)) may be provided based at least on the target coding rate.

The first CSI request field is used at least to indicate a report of the CSI. The size of the first CSI request field may be a prescribed value. The size of the first CSI request field may be zero, may be one, may be two, or may be three.

The DCI format 0_1 is configured to include at least some or all of 2A to 2G.

2A) DCI format specification field

2B) Frequency domain resource assignment field

2C) Time domain resource assignment field

2D) Frequency hopping flag field

2E) MCS field

2F) Second CSI request field

2G) BWP field

The BWP field may be used to indicate the uplink BWP to which the PUSCH scheduled by the DCI format 0_1 is mapped.

The second CSI request field is used at least to indicate a report of the CSI. The size of the second CSI request field may be provided based at least on a parameter ReportTriggerSize of the higher layer.

The downlink DCI format includes at least one of or both the DCI format 1_0 and the DCI format 1_1.

The DCI format 1_0 is configured to include at least some or all of 3A to 3H.

3A) DCI format specification field (Identifier for DCI formats field)

3B) Frequency domain resource assignment field

3C) Time domain resource assignment field

3D) Frequency hopping flag field

3E) Modulation and Coding Scheme field (MCS field)

3F) First CSI request field

3G) PDSCH to HARQ feedback timing indicator field

3H) PUCCH resource indicator field

The timing indication field from the PDSCH to the HARQ feedback may be a field indicating a timing K1. In a case that the index of the slot including the last OFDM symbol of the PDSCH is a slot n, the index of the slot including the PUCCH or the PUSCH including at least HARQ-ACK corresponding to the transport block included in the PDSCH may be n+K1. In a case that the index of the slot including the last OFDM symbol of the PDSCH is a slot n, the index of the slot including the OFDM symbol at the head of the PUCCH or the OFDM symbol at the head of the PUSCH including at least HARQ-ACK corresponding to the transport block included in the PDSCH may be n+K1.

The PUCCH resource indication field may be a field indicating indexes of one or a plurality of PUCCH resources included in the PUCCH resource set.

The DCI format 1_1 is configured to include at least some or all of 4A to 4J.

4A) DCI format specification field (Identifier for DCI formats field)

4B) Frequency domain resource assignment field

4C) Time domain resource assignment field

4D) Frequency hopping flag field

4E) Modulation and Coding Scheme field (MCS field)

4F) First CSI request field

4G) PDSCH to HARQ feedback timing indicator field

4H) PUCCH resource indicator field

4J) BWP field

The BWP field may be used to indicate the downlink BWP to which the PDSCH scheduled by the DCI format 1_1 is mapped.

In various aspects of the present embodiment, the number of resource blocks indicates the number of resource blocks in the frequency domain unless otherwise specified.

The downlink grant is used at least for scheduling a single PDSCH in a single serving cell.

The uplink grant is used at least for scheduling a single PUSCH in a single serving cell.

A single physical channel may be mapped to a single serving cell. A single physical channel may be mapped to a single BWP configured to a single carrier included in a single serving cell.

In the terminal apparatus 1, one or a plurality of COntrol REsource SETs (CORESETs) may be configured. The terminal apparatus 1 monitors the PDCCH in the one or plurality of control resource sets. Here, monitoring of the PDCCH in the one or plurality of control resource sets may include monitoring of one or a plurality of PDCCHs corresponding to the one or plurality of control resource sets, respectively. Note that the PDCCH may include a set of one or a plurality of PDCCH candidates and/or one or a plurality of PDCCH candidates. Also, monitoring of the PDCCH may include monitoring and detecting the PDCCH and/or a DCI format transmitted via the PDCCH.

The control resource set may indicate a time-frequency domain to which one or a plurality of PDCCHs can be mapped. The control resource set may be an area in which the terminal apparatus 1 monitors the PDCCH. The control resource set may include continuous resources (Localized resources). The control resource set may include non-continuous resources (distributed resources).

In the frequency domain, the unit of mapping of the control resource set may be a resource block. In the frequency domain, for example, the unit of mapping of the control resource set may be six resource blocks. In the time domain, the unit of mapping of the control resource set may be an OFDM symbol. In the time domain, for example, the unit of mapping of the control resource set may be one OFDM symbol.

Mapping of the control resource set to the resource block may be provided based at least on the higher layer parameter. The higher layer parameter may include a bitmap for a Resource Block Group (RBG). The resource block group may be provided by six continuous resource blocks.

The number of OFDM symbols included in the control resource set may be provided based at least on the higher layer parameter.

A certain control resource set may be a Common control resource set. The common control resource set may be a control resource set configured commonly to a plurality of terminal apparatuses 1. The common control resource set may be provided at least based on some or all of the MIB, the first system information, the second system information, the common RRC signaling, and a cell ID. For example, the time resource and/or the frequency resource of the control resource set configured to monitor the PDCCH to be used for scheduling the first system information may be provided based at least on the MIB.

The control resource set configured by the MIB is also referred to as CORESET #0. CORESET #0 may be a control resource set of index #0.

A certain control resource set may be a Dedicated control resource set. The dedicated control resource set may be a control resource set configured to be used exclusively for the terminal apparatus 1. The dedicated control resource set may be provided based at least on some or all of the dedicated RRC signaling and values of C-RNTI.

The set of PDCCH candidates monitored by the terminal apparatus 1 may be defined in terms of a search space. In other words, the set of PDCCH candidates monitored by the terminal apparatus 1 may be provided by the search space.

The search space may be configured to include one or a plurality of PDCCH candidates at one or a plurality of Aggregation levels. The aggregation level of the PDCCH candidates may indicate the number of CCEs included in the PDCCH. The PDDCH candidate may be mapped to one or a plurality of CCEs.

The terminal apparatus 1 may monitor at least one or a plurality of search spaces in a slot in which Discontinuous reception (DRX) is not configured. The DRX may be provided based at least on a higher layer parameter. The terminal apparatus 1 may monitor at least one or a plurality of Search space sets in the slot in which the DRX is not configured.

The search space set may be configured to include at least one or a plurality of search spaces.

Each search space set may be associated at least with one control resource set. Each search space set may be included in one control resource set. An index of the control resource set associated with the search space set may be provided to each search space set.

A physical resource of the search space includes a Control Channel Element (CCE). The CCE includes a prescribed number of Resource Element Groups (REGs). For example, the CCE may include six REGs. The REG may include one Physical Resource Block (PRB) during one OFDM symbol. In other words, the REG may be configured to include 12 Resource Elements (REs). The PRB is also simply referred to as a Resource Block (RB).

The PDSCH is used at least to transmit the transport block. The PDSCH may be used at least to transmit a random access message 2 (random access response). The PDSCH may be used at least to transmit system information including parameters used for initial access.

In FIG. 1, the following downlink physical signals are used for the downlink radio communication. The downlink physical signals may not be used for transmitting information output from a higher layer, but is used by the physical layer.
Synchronization Signal (SS)
DownLink DeModulation Reference Signal (DL DMRS)
Channel State Information-Reference Signal (CSI-RS)
DownLink Phase Tracking Reference Signal (DL PTRS)

The synchronization signal is used for the terminal apparatus 1 to establish synchronization in a frequency domain and/or a time domain of the downlink. The synchronization signal includes a Primary Synchronization Signal (PSS) and a Secondary Synchronization Signal (SSS).

An SS block (SS/PBCH block) is configured to include at least some or all of the PSS, the SSS, and the PBCH.

The DL DMRS is associated with transmission of the PBCH, PDCCH and/or PDSCH. The DL DMRS is multiplexed to the PBCH, the PDCCH and/or the PDSCH. The terminal apparatus 1 may use the DL DMRS corresponding to the PBCH, the PDCCH, or the PDSCH to perform channel compensation of the PBCH, the PDCCH, or the PDSCH.

The CSI-RS may be a signal used at least to calculate channel state information. A pattern of the CSI-RS assumed by the terminal apparatus may be provided at least by a higher layer parameter.

The PTRS may be a signal used at least to compensate for phase noise. A pattern of the PTRS assumed by the terminal apparatus may be provided based at least on a higher layer parameter and/or the DCI.

The DL PTRS may be associated with a DL DMRS group that includes at least an antenna port used for one or a plurality of DL DMRSs.

The downlink physical channel and the downlink physical signal are also collectively referred to as the downlink signal. The uplink physical channel and the uplink physical signal are also collectively referred to as the uplink signal. The downlink signal and the uplink signal are also collectively referred to as the physical signal. The downlink signal and the uplink signal are also collectively referred to as the signal. The downlink physical channel and the uplink physical channel are collectively referred to as the physical channel. The downlink physical signal and the uplink physical signal are collectively referred to as the physical signal.

A Broadcast CHannel (BCH), an Uplink-Shared CHannel (UL-SCH), and a Downlink-shared CHannel (DL-SCH) are transport channels. A channel used in a Medium Access Control (MAC) layer is referred to as a transport channel. A unit of the transport channel used in the MAC layer is also referred to as a transport block (TB) or an MAC PDU. Control of the Hybrid Automatic Repeat reQuest (HARQ) is performed for each transport block in the MAC layer. The transport block is a unit of data that the MAC layer delivers to the physical layer. In the physical layer, the transport block is mapped to a codeword, and modulation processing is performed for each codeword.

The base station apparatus 3 and the terminal apparatus 1 exchange (transmit and/or receive) higher layer signals in the higher layer. For example, the base station apparatus 3 and the terminal apparatus 1 may transmit and/or receive, in a Radio Resource Control (RRC) layer, RRC signaling (a Radio Resource Control (RRC) message and/or Radio Resource Control (RRC) information). Also, the base station apparatus 3 and the terminal apparatus 1 may transmit and/or receive, in the MAC layer, a MAC Control Element (CE). Here, the RRC signaling and/or the MAC CE is also referred to as the higher layer signaling.

The PUSCH and the PDSCH may be used at least to transmit the RRC signaling and/or the MAC CE. Here, the RRC signaling transmitted from the base station apparatus 3 through the PDSCH may be signaling common to a plurality of terminal apparatuses 1 in a serving cell. The signaling common to the plurality of terminal apparatuses 1 in the serving cell is also referred to as common RRC signaling. The RRC signaling transmitted from the base station apparatus 3 through the PDSCH may be signaling dedicated to a certain terminal apparatus 1 (also referred to as dedicated signaling or UE specific signaling). The signaling dedicated to the terminal apparatus 1 is also referred to as dedicated RRC signaling. A serving cell-specific higher layer parameter may be transmitted using the signaling common to the plurality of terminal apparatuses 1 in the serving cell or the signaling dedicated to a certain terminal apparatus 1. A UE-specific higher layer parameter may be transmitted using signaling dedicated to a certain terminal apparatus 1.

A Broadcast Control CHannel (BCCH), a Common Control CHannel (CCCH), and a Dedicated Control CHannel (DCCH) are logical channels. For example, the BCCH is a higher layer channel used to transmit the MIB. Furthermore, the Common Control CHannel (CCCH) is a higher layer channel used to transmit information common to the plurality of terminal apparatuses 1. Here, the CCCH may be used for a terminal apparatus 1 that is not RRC-connected, for example. Moreover, a Dedicated Control CHannel (DCCH) is a higher layer channel used at least to transmit dedicated control information to the terminal apparatus 1. Here, the DCCH may be used for a terminal apparatus 1 that is RRC-connected, for example.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to the PUSCH in the physical channel. The DL-SCH in the transport channel may be mapped to the PDSCH in the physical channel. The BCH in the transport channel may be mapped to the PBCH in the physical channel.

A structural example of the terminal apparatus 1 according to the one aspect of the present embodiment will be described below.

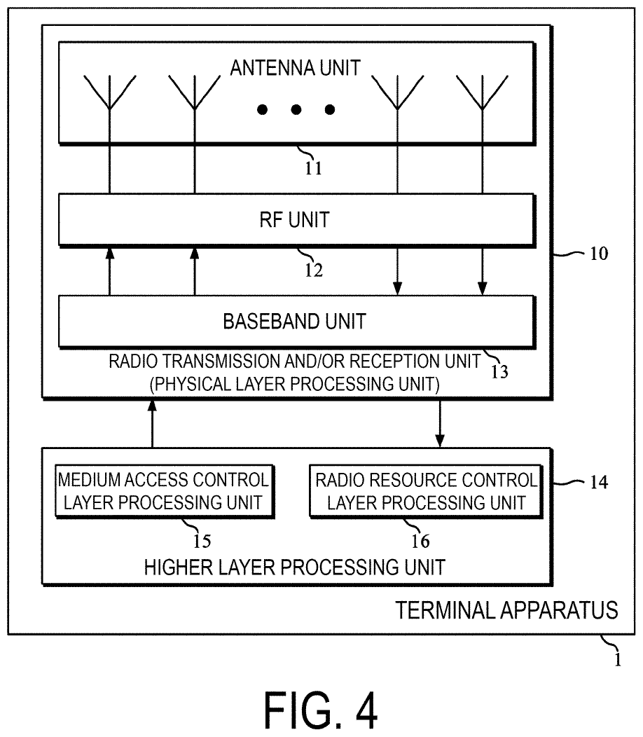

FIG. 4 is a schematic block diagram illustrating a structure of the terminal apparatus 1 according to an aspect of the present embodiment. As illustrated, the terminal apparatus 1 is configured to include a radio transmission and/or reception unit 10 and a higher layer processing unit 14. The radio transmission and/or reception unit 10 is configured to include at least some or all of an antenna unit 11, a Radio Frequency (RF) unit 12, and a baseband unit 13. The higher layer processing unit 14 is configured to include at least some or all of a medium access control layer processing unit 15 and a radio resource control layer processing unit 16. The radio transmission and/or reception unit 10 is also referred to as a transmitter, a receiver, or a physical layer processing unit.

The higher layer processing unit 14 outputs uplink data (transport block) generated by a user operation or the like to the radio transmission and/or reception unit 10. The higher layer processing unit 14 performs processing of an MAC layer, a Packet Data Convergence Protocol (PDCP) layer, a Radio Link Control (RLC) layer, and an RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. In other words, the radio resource control layer processing unit 16 sets the various configuration information/parameters based on the information indicating the various configuration information/parameters received from the base station apparatus 3. Note that the configuration information may include information related to the processing or configurations of the physical channel, the physical signal (that is, the physical layer), the MAC layer, the PDCP layer, the RLC layer, and the RRC layer. The parameters may be higher layer parameters.

The radio transmission and/or reception unit 10 performs processing of the physical layer, such as modulation, demodulation, coding, and decoding. The radio transmission and/or reception unit 10 demultiplexes, demodulates, and decodes a received physical signal and outputs the decoded information to the higher layer processing unit 14. The radio transmission and/or reception unit 10 generates a physical signal by performing modulation and coding of data and generating a baseband signal (conversion into a time-continuous signal) and transmits the physical signal to the base station apparatus 3.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the converted digital signal, performs a Fast Fourier Transform (FFT) on the signal from which the CP has been removed, and extracts a signal in the frequency domain.

The baseband unit 13 generates an OFDM symbol by performing Inverse Fast Fourier Transform (IFFT) on the data, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up converts the analog signal into a signal of a carrier frequency, and transmits the up converted signal via the antenna unit 11. Also, the RF unit 12 amplifies power. In addition, the RF unit 12 may have a function of controlling transmit power. The RF unit 12 is also referred to as a transmit power controller.

Hereinafter, a structural example of the base station apparatus 3 according to an aspect of the present embodiment will be described below.

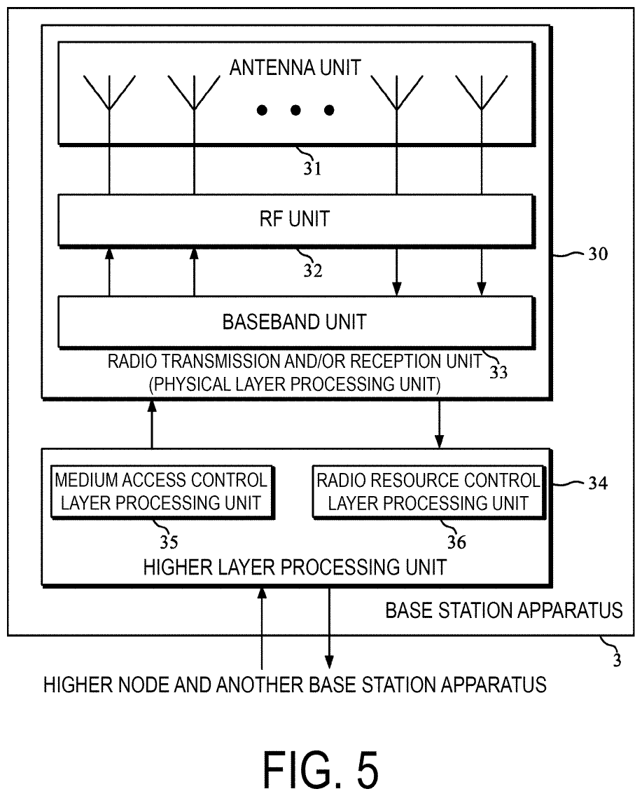

FIG. 5 is a schematic block diagram illustrating a structure of the base station apparatus 3 according to an aspect of the present embodiment. As illustrated, the base station apparatus 3 is configured to include a radio transmission and/or reception unit 30 and a higher layer processing unit 34. The radio transmission and/or reception unit 30 is configured to include an antenna unit 31, an RF unit 32, and a baseband unit 33. The higher layer processing unit 34 is configured to include a medium access control layer processing unit 35 and a radio resource control layer processing unit 36. The radio transmission and/or reception unit 30 is also referred to as a transmitter, a receiver, or a physical layer processing unit.

The higher layer processing unit 34 performs processing of an MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (transport block) mapped to a PDSCH, system information, an RRC message, an MAC CE, and the like, and outputs the data to the radio transmission and/or reception unit 30. Further, the radio resource control layer processing unit 36 manages various types of configuration information/parameters for each terminal apparatus 1. The radio resource control layer processing unit 36 may set various types of configuration information/parameters for each terminal apparatus 1 via higher layer signals. In other words, the radio resource control layer processing unit 36 transmits/broadcasts information indicating various types of configuration information/parameters. Note that the configuration information may include information related to the processing or configurations of the physical channel, the physical signal (that is, the physical layer), the MAC layer, the PDCP layer, the RLC layer, and the RRC layer. The parameters may be higher layer parameters.

The functionality of the radio transmission and/or reception unit 30 is similar to the functionality of the radio transmission and/or reception unit 10, and description thereof will thus be omitted.

Each of the units having the reference signs 10 to 16 included in the terminal apparatus 1 may be implemented as a circuit. Each of the units having the reference signs 30 to 36 included in the base station apparatus 3 may be implemented as a circuit.

The terminal apparatus 1 may perform Carrier sense prior to transmission of a physical signal. Also, the base station apparatus 3 may perform carrier sense prior to transmission of a physical signal. The carrier sense may be to perform Energy detection on a Radio channel. Whether the physical signal can be transmitted may be provided based on the carrier sense performed prior to transmission of the physical signal. In a case that the amount of energy detected in carrier sense performed prior to transmission of a physical signal is greater than a prescribed threshold value, for example, the transmission of the physical channel may not be performed, or it may be determined that the transmission is not possible. Also, in a case that the amount of energy detected in the carrier sense performed prior to the transmission of the physical signal is smaller than the prescribed threshold value, the transmission of the physical channel may be performed, or it may be determined that the transmission is possible. Moreover, in a case that the amount of energy detected in the carrier sense performed prior to the transmission of the physical signal is equal to the prescribed threshold value, the transmission of the physical channel may be performed or may not be performed. In other words, in a case that the amount of energy detected in the carrier sense performed prior to the transmission of the physical signal is equal to the prescribed threshold value, it may be determined that the transmission is not possible, or it may be determined that the transmission is possible.

A procedure in which whether the transmission of the physical channel is possible based on the carrier sense is also referred to as Listen Before Talk (LBT). A situation in which the transmission of the physical signal is determined to be not possible as a result of the LBT is also referred to as a busy state or busy. For example, the busy state may be a state in which the amount of energy detected in the carrier sense is greater than the prescribed threshold value. In addition, the situation in which the transmission of the physical signal is determined to be possible as a result of the LBT is also referred to as an idle state or idle. For example, the idle state may be a state in which the amount of energy detected in the carrier sense is smaller than the prescribed threshold value.

The terminal apparatus 1 may multiplex uplink control information (UCI) to the PUCCH and transmit the PUCCH. The terminal apparatus 1 may multiplex the UCI to the PUSCH and transmit the PUSCH. The UCI may include at least one of downlink Channel State Information (CSI), a Scheduling Request (SR) indicating a request for a PUSCH resource, and a Hybrid Automatic Repeat request ACKnowledgement (HARQ-ACK) for downlink data (a Transport block, a Medium Access Control Protocol Data Unit (MAC PDU), a Downlink-Shared Channel (DL-SCH), and/or a Physical Downlink Shared Channel (PDSCH)).

In a case that downlink data is successfully decoded, an ACK for the downlink data is generated. In a case that downlink data is not successfully decoded, a NACK for the downlink data is generated. The HARQ-ACK may include at least a HARQ-ACK bit corresponding at least to one transport block. The HARQ-ACK bit may indicate an ACKnowledgement (ACK) or a Negative-ACKnowledgement (NACK) corresponding to one or a plurality of transport blocks. The HARQ-ACK may include at least a HARQ-ACK codebook including one or a plurality of HARQ-ACK bits. The fact that the HARQ-ACK bit corresponds to one or a plurality of transport blocks may mean that the HARQ-ACK bit corresponds to the PDSCH including the one or plurality of transport blocks.

The HARQ-ACK may also be referred to as an ACK/NACK, HARQ feedback, HARQ-ACK feedback, an HARQ response, a HARQ-ACK response, HARQ information, HARQ-ACK information, HARQ control information, and HARQ-ACK control information.

The terminal apparatus 1 may report the HARQ-ACK information to the base station apparatus 3 using the HARQ-ACK codebook in a slot indicated by a value of PDSCH to HARQ feedback timing indicator field included in the DCI format 1_0 or the DCI format 1_1 corresponding to PDSCH reception. The value of the PDSCH to HARQ feedback timing indicator field is also referred to as a HARQ-ACK timing or K1.

In a case that a higher layer parameter pdsch-AggregationFactor is provided to the terminal apparatus 1, N_{PDSCH}^{repeat} may be a value of the pdsch-AggregationFactor. In a case that the higher layer parameter pdsch-AggregationFactor is not provided to the terminal apparatus 1, N_{PDSCH}^{repeat} may be one. The terminal apparatus 1 may report the HARQ-ACK information for PDSCH reception from the slot n-N_{PDSCH}^{repeat}+1 to the slot n using PUCCH transmission and/or PUSCH transmission in the slot n+k. Here, k may be the number of slots indicated by PDSCH-to-HARQ_feedback timing indicator field included in the DCI format corresponding to the PDSCH reception. Also, in a case that PDSCH-to-HARQ_feedback timing indicator field is not included in the DCI format, k may be provided by a higher layer parameter dl-DataToUL-ACK.

The scheme of the HARQ-ACK codebook may include at least a semi-static HARQ-ACK. The semi-static HARQ-ACK is also referred to as HARQ-ACK Type1.

A set of M_{A, c} occasions for candidate PDSCH receptions may be determined based at least on a set of K₁ (HARQ-ACK timing value) associated with an uplink BWP, default PDSCH time domain resource allocation, higher layer parameter PDSH-TimeDomainResourceAllocationList, higher layer parameter TDD-UL-DL-ConfigurationCommon, and/or a higher layer parameter TDD-UL-DL-ConfigDedicated.

In a case that the terminal apparatus 1 is configured to monitor the PDCCH including the DCI format 1_0 and is configured not to monitor the PDCCH including the DCI format 1_1, the HARQ-ACK timing value K1 may be some or all of (1, 2, 3, 4, 5, 6, 7, and 8). In a case that the terminal apparatus 1 is configured to monitor the PDCCH including the DCI format 1_1, the HARQ-ACK timing value K1 may be provided by a higher layer parameter dl-DataToUL-ACK.

The number of elements (cardinality) of M_{A, c} is defined by the total number M_{c} of occasions for the PDSCH receptions of the serving cell c corresponding to the HARQ-ACK information bit or of occasions for the SPS PDSCH release. In other words, M_{c} may be the number of elements of M_{A, c}. Also, M_{c} may be a codebook size of the HARQ-ACK information.

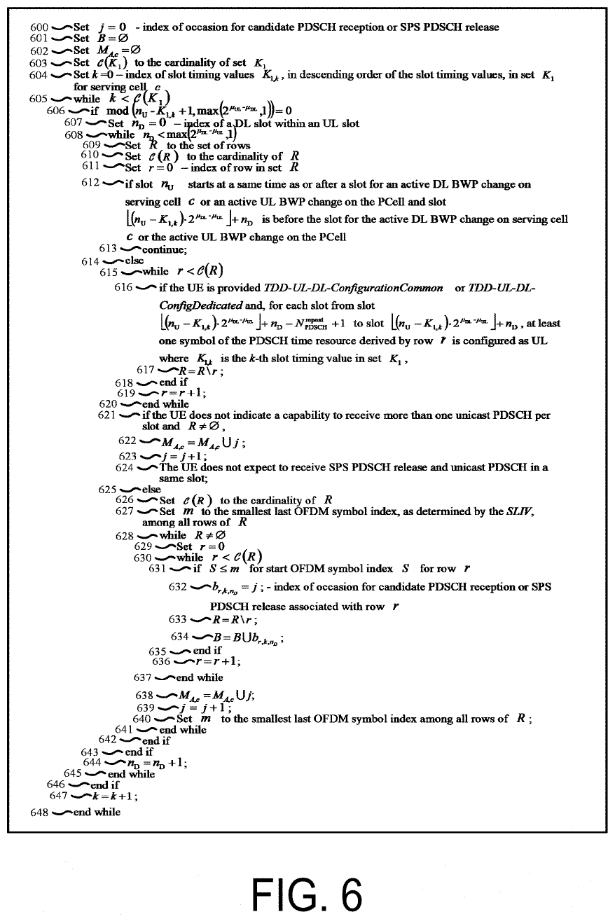

FIG. 6 is a diagram illustrating an example of a procedure for determining a set of M_{A, c} occasions for candidate PDSCH receptions according to the present embodiment. The number of bits of the HARQ-ACK information to be transmitted by the terminal apparatus 1 may be determined in this procedure.

(600) An index j of the occasion for the candidate PDSCH reception and/or for the SPS PDSCH release is configured to 0, and the procedure proceeds to 601.

(601) A set B for storing the candidate PDSCH reception is configured to be an empty set, and the procedure proceeds to 602.

(602) M_{A, c} is configured to be the empty set, and the procedure proceeds to 603.

(603) The number (cardinality) of the HARQ-ACK timing values K1 included in the set of K1 is configured to be C(K₁), and the procedure proceeds to 604.

(604) The index k of the HARQ-ACK timing value K1 included in the set of K1 is configured to be 0, and the procedure proceeds to 605. Here, the value of K1 may be arranged in the descending order for each serving cell. In a case that the set of K1 is (5, 6, 7), for example, the value of K₁ indicated by k=0 may be 5.

(605) In a case that the index k of K1 is smaller than C(K₁), the procedure proceeds to 606. In a case that the index k of K1 is greater than C(K₁) or the same as C(K₁), the procedure proceeds to 648.

(606) In a case that mod(n_{U}−K_{1, k}+1, max(2μ^{UL-μDL}, 1))=0 is satisfied, the procedure proceeds to 607. In a case that mod(n_{U}−K_{1, k}+1, max(2μ^{UL-μDL}, 1))=0 is not satisfied, the procedure proceeds to 646.

(607) An index n_{D} of the downlink slot is configured to zero within a range of one uplink slot, and the procedure proceeds to 608.

(608) In a case that n_{D} is smaller than max(2μ^{DL-μUL}, 1), the procedure proceeds to 609. In a case that n_{D} is greater than max(2μ^{DL-μUL}, 1), the procedure proceeds to 645. Here, in a case that μ_{DL} is greater than μ_{UL}, one uplink slot corresponds to a plurality of downlink slots.

(609) All rows in a time domain resource allocation table are configured to be R, and the procedure proceeds to 610.

(610) The number of elements (cardinality) of R is configured to be C(R), and the procedure proceeds to 611.

(611) An index r in the row of R is configured to be zero, and the procedure proceeds to 612.

(612) In a case that the slot n_{U} is the same slot as or a slot after a slot for the active downlink BWP change on the serving cell c or for the active uplink BWP change on the PCell, and the slot floor((n_{U}−K_{1, k})·2μ^{DL-μUL})+n_{D} is a slot before a slot for the active downlink BWP change on the serving cell c or for the active uplink BWP change on the PCell, 613 is performed. In a case that the condition in 612 is not satisfied, the procedure proceeds to 614 without performing 613. The floor function is defined as a maximum integer of equal to or less than a real number with respect to the real number.

(613) Procedure proceeds to 643.

(614) In a case that the condition in 612 is not satisfied, the procedure proceeds to 615.

(615) In a case that r is smaller than C(R), the procedure proceeds to 616. In a case that r is greater than or equal to C(R), the procedure proceeds to 620.

(616) In a case that a higher layer parameter TDD-UL-DL-ConfigurationCommon or TDD-UL-DL-ConfigDedicated is provided to the terminal apparatus 1 and at least one symbol of the PDSCH time domain resource derived by the row r from the slot floor((n_{U}−K_{1, k})·2μ_{DL-μUL})+n_{D}−N_{PDSCH}^{repeat}−1 to the slot floor((n_{U}−K_{1, k})·2μ^{DL-μUL})+n_{D} includes the uplink, (617) the row r is excluded from R, and the procedure proceeds to 618. In a case that the condition in 616 is not satisfied, the procedure proceeds to 618.

(618) The conditional statement in 616 is ended, and the procedure proceeds to 619.

(619) r is incremented by one, and the procedure proceeds to 620.

(620) In a case that r is smaller than C(R), the procedure proceeds to 616. In a case that r is greater than or equal to C(R), the procedure proceeds to 621.

(621) In a case that the terminal apparatus 1 does not provide a notification indicating Capability of receiving two or more PDSCHs in one slot, and R is not empty, the procedure proceeds to 622.

(622) The terminal apparatus 1 saves the union of M_{A, c} and the index k of K1 in M_{A, c} and procedure proceeds to 623.

(623) j is incremented by one, and the procedure proceeds to 624.

(624) The terminal apparatus 1 may not expect to receive the PDSCH and the SPS PDSCH release at the same time in one slot. The procedure proceeds to 625.

(625) In a case that the condition in 621 is not satisfied, the procedure proceeds to 626.

(626) The number of elements (Cardinality) of R is set to be C(R), and the procedure proceeds to 627.

(627) The last and the smallest OFDM symbol index from among the candidate PDSCH receptions R is configured to be m, and the procedure proceeds to 628. Here, the candidate PDSCH reception may be provided by a start and length indicator value (SLIV) included in each row of R. Also, in a case that the terminal apparatus 1 is scheduled to receive the PDSCH, the SLIV may be determined based at least on a value of a Time Domain Resource assignment field included in the DCI.

(628) In a case that R is not an empty set, the procedure proceeds to 629. In a case that R is an empty set, the procedure proceeds to 641.

(629) r is configured to be zero, and the procedure proceeds to 630.

(630) In a case that r is smaller than C(R), the procedure proceeds to 631. In a case that r is greater than or equal to C(R), the procedure proceeds to 637.

(631) In a case that the start OFDM symbol index S of the candidate PDSCH reception in the row r is smaller than m determined in (627), the procedure proceeds to 632. In a case that S is greater than or equal to m, the procedure proceeds to 635.

(632) j is saved in b_{r, k, nD}, and the procedure proceeds to 633. Here, b_{r, k, nD} may be a set of occasion indexes j for the candidate PDSCH reception r in K_{1, k}.

(633) The row r is excluded from R, and the procedure proceeds to 634.

(634) The union of B and b_{r, k} is saved in B, and the procedure proceeds to 635.

(635) The conditional statement in 631 is ended, and the procedure proceeds to 636.

(636) r is incremented by one, and the procedure proceeds to 637.

(637) In a case that the condition in 630 is satisfied, the procedure proceeds to 631. In a case that the condition in 630 is not satisfied, the procedure proceeds to 638.

(638) The union of M_{A, c} and j is saved in M_{A, c}, and the procedure proceeds to 639.

(639) j is incremented by one, and the procedure proceeds to 640.

(640) The last and the smallest OFDM symbol index from among the candidate PDSCH receptions R is configured to be m, and the procedure proceeds to 641.

(641) In a case that R is not empty, the procedure proceeds to 629. In a case that R is empty, the procedure proceeds to 642.

(642) The conditional statement in 621 and/or 625 is ended, and the procedure proceeds to 643.

(643) The conditional statement in 612 and/or 614 is ended, and the procedure proceeds to 644.

(644) n_{D} is incremented by one, and the procedure proceeds to 645.

(645) In a case that n_{D} is smaller than max(2μ^{DL-μUL}, 1), the procedure proceeds to 609. In a case that n_{D} is greater than or equal to max(2μ^{DL-μUL}, 1), the procedure proceeds to 646.

(646) The conditional statement in 606 is ended, and the procedure proceeds to 647.

(647) k is incremented by one, and the procedure proceeds to 648.

(648) In a case that the index k of K1 is smaller than C(K1), the procedure proceeds to 606. In a case that the index k of K1 is greater than or equal to C(K₁), the procedure is ended.

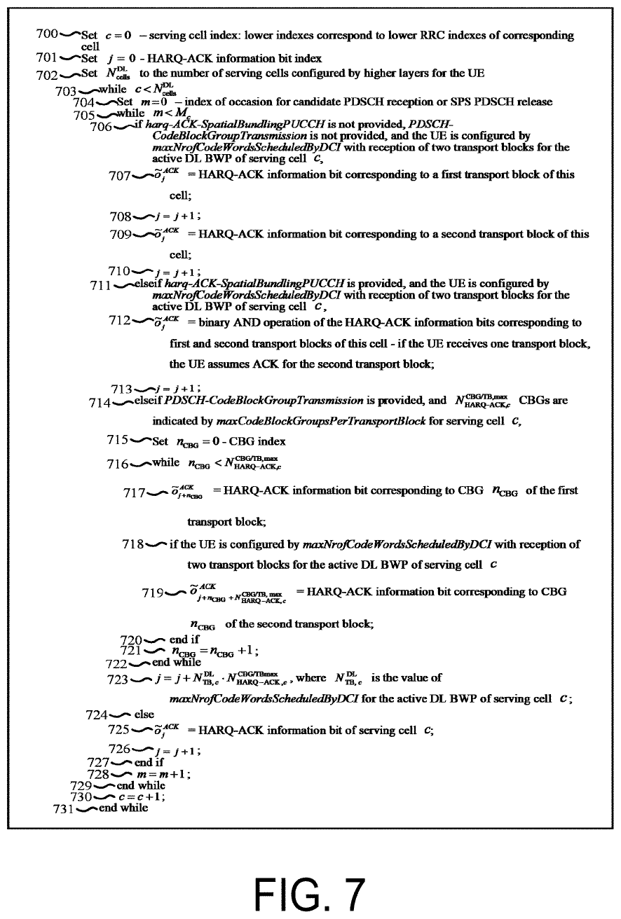

M_{A, c} determined by the procedure illustrated in FIG. 7 may be the number of HARQ-ACK bits transmitted by the terminal apparatus 1.

In occasions for candidate PDSCH reception corresponding to one or a plurality of rows of R in which b_{r, k, nD} included in B is the same, the terminal apparatus 1 may not expect to receive two or more PDSCHs in the same slot.

The candidate PDSCH reception may be the candidate capable of PDSCH reception indicated by the SLIV. The number of PDSCHs that the terminal apparatus 1 actually receives in one slot may be a value that is the same as or smaller than the number of candidate PDSCH receptions.

In a case that the terminal apparatus 1 receives an SPS PDSCH, SPS PDSCH release, or a PDSCH scheduled by the DCI format 1_0, that the terminal apparatus 1 is included in one serving cell, that M_{A, c} is 1, and that a higher layer parameter PDSCH-CodeBlockGroupTransmission is provided to the terminal apparatus 1, the terminal apparatus 1 may generate HARQ-ACK information of only a transport block in the PDSCH or of only the SPS PDSCH release.

In a case that the Uplink subcarrier spacings and the Downlink subcarrier spacings are the same, the present embodiment may be used. In a case that the Uplink subcarrier spacings and the Downlink subcarrier spacings are different from each other, the present embodiment may be used.

FIG. 7 is a diagram illustrating a procedure of an example in which the terminal apparatus 1 determines a HARQ-ACK information bit of a HARQ-ACK codebook transmitted through the PUCCH in the present embodiment. The HARQ-ACK information bit corresponding to M_{A, c} determined through the procedure in FIG. 6 may be determined through this procedure.

(700) The serving cell index c is configured to be zero, and the procedure proceeds to 701.

(701) The index j of the HARQ-ACK information bit is configured to be zero, and the procedure proceeds to 702.

(702) The number of serving cells including the terminal apparatus 1 is configured to be N_{cells}^{DL}, and the procedure proceeds to 703.

(703) In a case that c is smaller than N_{cells}^{DL}, the procedure proceeds to 704. In a case that c is greater than or equal to N_{cells}^{DL}, the procedure is ended.

(704) The occasion index m of the candidate PDSCH reception or the SPS PDSCH release is configured to be zero, and the procedure proceeds to 705.

(705) In a case that the index m is smaller than M_{c}, the procedure proceeds to 706. In a case that the index m is greater than or equal to M_{c}, the procedure proceeds to 728.

(706) In a case that the higher layer parameter harq-ACK-SpatialBundlingPUCCH is not provided to the terminal apparatus 1, that the higher layer parameter PDSCH-CodeBlockGroupTransmission is not provided to the terminal apparatus 1, and that the terminal apparatus 1 includes a higher layer parameter maxNrofCodeWordsScheduledByDCI indicating reception of two transport blocks in the active downlink BWP of the serving cell c, (707) the HARQ-ACK information bit corresponding to the first transport block of the cell is saved in oⱼ^{ACK}, (708) j is incremented by one, then (709) a HARQ-ACK information bit corresponding to the second transport block of the cell is saved in oⱼ^{AcK}, (710) j is incremented by one, and the procedure proceeds to 728. In a case that the condition in 706 is not satisfied, the procedure proceeds to 711.

(711) In a case that the higher layer parameter harq-ACK-SpatialBundlingPUCCH is provided to the terminal apparatus 1, and that the terminal apparatus 1 includes the higher layer parameter maxNrofCodeWordsScheduledByDCI indicating reception of two transport blocks in the active downlink BWP of the serving cell c, (712) a binary AND operation is performed on HARQ-ACK information bits corresponding to the first transport block and the second transport block in the cell, the result thereof is saved in oⱼ^{ACK}, (713) j is incremented by one, and the procedure proceeds to 728. In a case that the condition in 711 is not satisfied, the procedure proceeds to 714. Here, only in a case that all of a plurality of input bits in the binary AND operation are 1, the result of the binary AND operation is 1. In a case that all of the plurality of input bits in the binary AND operation are not 1, the result of the binary AND operation is 0. In a case that the HARQ-ACK information bit corresponding to the first transport block is 1 and the HARQ-ACK information bit corresponding to the second transport block is 1, for example, the result of the binary AND operation of the HARQ-ACK information bit corresponding to the first transport block and the HARQ-ACK information bit corresponding to the second transport block is 1.

(714) In a case that the higher layer parameter PDSCH-CodeBlockGroupTransmission is provided to the terminal apparatus 1, and that N_{HARQ-ACK, c}^{CBG/TB, max} CBGs are provided by the higher layer parameter maxCodeBlockGroupsPerTransportBlock in the serving cell c, the procedure proceeds to 715. In a case that the condition in 814 is not satisfied, the procedure proceeds to 725. Here, N_{HARQ-Ack c}^{CBG/TB, max} may be the maximum number of CBGs in one transport block in the serving cell c.

(715) The CBG index n_{CBG} is configured to be zero, and the procedure proceeds to 716.

(716) In a case that n_{CBG} is smaller than N_{HARQ-Ack c}^{CBG/TB, max} the procedure proceeds to 717. In a case that n_{CBG} is greater than or equal to N_{HARQ-AGK, c}^{CBG/TB, max} the procedure proceeds to 722.

(717) The HARQ-ACK information bits corresponding to n_{CBG} CBGs of the first transport block is saved in o_{j+nCBG}^{AcK}, and the procedure proceeds to 718.

(718) In a case that the terminal apparatus 1 is configured to receive two transport blocks in the downlink BWP of the serving cell c by the higher layer parameter maxNrofCodeWordsScheduledByDCI, (719) the HARQ-ACK information bits corresponding to n_{CBG} CBGs of the second transport is saved in o_{j+nCBG+nmax}^{ACK}, the conditional statement in 720 is ended, and the procedure proceeds to 721. In a case that the condition in 718 is not satisfied, the procedure proceeds to 721.

(721) n_{CBG} is incremented by one, and the procedure proceeds to 722.

(722) In a case that n_{CBG} is smaller than N_{HARQ-ACK, c}^{CBG/TB, max,} the procedure proceeds to 718. In a case that n_{CBG} is greater than or equal to N_{HARQ-AGK, c}^{CBG/TB, max}, the procedure proceeds to 723.

(723) j+N_{TB, c}^{DL}·N_{HARQ-ACK, c}^{CBG/TB, max} is HARQ-ACK, is saved in j, and the procedure proceeds to 724.

(724) In a case that condition in 706, 711, and/or 714 is not satisfied, the procedure proceeds to 725.

(725) The HARQ-ACK information bit in the serving cell c is saved in oⱼ^{ACK}, and the procedure proceeds to 726.

(726) j is incremented by one, and the procedure proceeds to 727.

(727) The conditional statement in 706, 711, 714, and/or 724 is ended, and the procedure proceeds to 728.

(728) m is incremented by one, and the procedure proceeds to 729.

(729) In a case that the index m is smaller than M_{c}, the procedure proceeds to 706. In a case that the index m is greater than or equal to M_{c}, the procedure proceeds to 730.

(730) c is incremented by one, and the procedure proceeds to 731.

(731) In a case that c is smaller than N_{cells}^{DL}, the procedure proceeds to 704. In a case that c is greater than or equal to N_{cells}^{DL}, the procedure is ended.

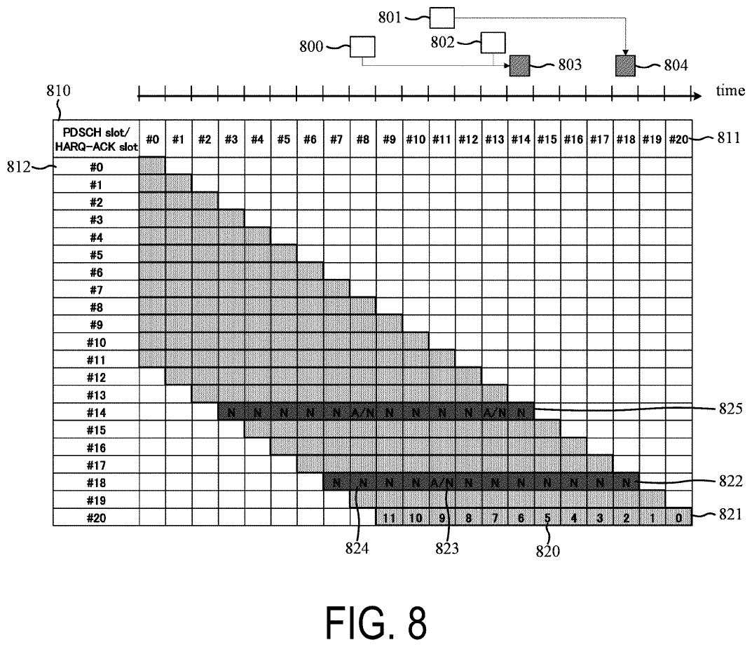

FIG. 8 is a diagram illustrating a method by which the terminal apparatus 1 determines a HARQ-ACK information bit of a transmitted HARQ-ACK codebook according to an aspect of the present embodiment.

In a table 810, the horizontal axis 811 represents a slot for the PDSCH, and the vertical axis 812 represents a slot for HARQ-ACK information.

For example, a set of K1 (HARQ-ACK timing values) is set to [0, 1, 2, 3, 4, 5, 6, 7, 8, 9, 10, 11] by the higher layer parameter. HARQ-ACK codebooks 821, 822, and 825 may be determined based at least on the set of the K1. Each bit of the HARQ-ACK codebooks may correspond to candidate PDSCH reception to be associated therewith. For example, in the HARQ-ACK codebook 821, the HARQ-ACK information bit 820 corresponds to a candidate PDSCH reception of the slot #15 to be associated by a HARQ-ACK timing value K1=5.

The PDSCH 800 is scheduled in the slot #8, and the HARQ-ACK information bit corresponding to the PDSCH 800 is included in the HARQ-ACK codebook 825 by the indication of the HARQ-ACK timing value K1=6. The PDSCH 802 is scheduled in the slot #13, and the HARQ-ACK information bit corresponding to the PDSCH 802 is included in the HARQ-ACK codebook 825 by the indication of the HARQ-ACK timing value K1=1. The HARQ-ACK codebook 825 includes the HARQ-ACK information bits corresponding to the PDSCH 800 and the PDSCH 802 and is transmitted in the slot #14 via the PUCCH 803 or the PUSCH 803. The PDSCH 801 is scheduled in the slot #13, and the HARQ-ACK information bit corresponding to the PDSCH 800 is included in the HARQ-ACK codebook 822 by the indication of the HARQ-ACK timing value K1=7 and is transmitted in the slot #18 via the PUCCH 804 or the PUSCH 804.

Hereinafter, a semi-static HARQ-ACK (first generation method) in the related art using a first HARQ-ACK codebook will be described using the HARQ-ACK codebook 822 in the slot #18 as an example. In the HARQ-ACK codebook 822, the HARQ-ACK information bit 823 is enabled (ACK or NACK) in a manner corresponding to the PDSCH 801. In the HARQ-ACK codebook 822, bits other than the HARQ-ACK information bit 823, that is, bits not corresponding to the PDSCH are set to be disabled (fixed to the NACK). For example, the HARQ-ACK information bit 824 is fixed to the NACK.

The fact that the PDSCH and the HARQ-ACK codebook are associated based on the HARQ-ACK timing may mean that the slot (an OFDM symbol or timing) in which the HARQ-ACK codebook is transmitted coincides with a slot (an OFDM symbol or a timing) indicated by the value of the PDSCH to HARQ feedback timing indicator field of the DCI format scheduling the PDSCH.

The fact that the PDSCH and the HARQ-ACK codebook are not associated based on the HARQ-ACK timing may mean that the slot (the OFDM symbol or the timing) in which the HARQ-ACK codebook is transmitted does not coincide with the slot (the OFDM symbol or the timing) indicated by the value of the PDSCH to HARQ feedback timing indicator field of the DCI format scheduling the PDSCH.

In the first generation method, the HARQ-ACK information for a PDSCH may be transmitted in the HARQ-ACK codebook to be transmitted in a slot indicated by K1. The K1 may be indicated by the DCI format. The PDSCH may be scheduled based at least on the DCI format.

In the first generation method, the HARQ-ACK information for the PDSCH may not be transmitted (may be set to the NACK) in the HARQ-ACK codebook to be transmitted in a slot other than the slot indicated by the K1.

In the first generation method, the HARQ-ACK information for the PDSCH may not be transmitted (may be set to the NACK) in the HARQ-ACK codebook to be transmitted in a slot that is not indicated by the K1.

In a second generation method, the HARQ-ACK information for a PDSCH may be transmitted in the HARQ-ACK codebook to be transmitted in a slot indicated by K1. The K1 may be indicated by the DCI format. The PDSCH may be scheduled based at least on the DCI format.

In the second generation method, the HARQ-ACK information for the PDSCH may be transmitted in the HARQ-ACK codebook to be transmitted in a slot other than the slot indicated by the K1.

In the second generation method, the HARQ-ACK information for the PDSCH may be transmitted in the HARQ-ACK codebook to be transmitted in a slot that is not indicated by the K1.

In the second generation method, HARQ-ACK information for the PDSCH may be transmitted in a slot other than the slot indicated by the K1 and in a slot subsequent to the slot in which the PDSCH is transmitted.

For the second generation method, a configuration of the slot in which the PDSCH is transmitted may take PDSCH processing Capability of the terminal apparatus 1 into consideration.

The HARQ-ACK codebook generated based on the first generation method may be a first HARQ-ACK codebook. The HARQ-ACK codebook generated based on the second generation method may be a second HARQ-ACK codebook.

Which of the first generation method and the second generation method the transmission of the HARQ-ACK information is provided by may be provided based at least on a prescribed value of a prescribed higher layer parameter. Which of the first generation method and the second generation method the HARQ-ACK information is provided by may be indicated by a value of a prescribed higher layer parameter.

Which of the first generation method and the second generation method the transmission of the HARQ-ACK information is provided by may be triggered by a prescribed value of a prescribed DCI format field. The prescribed value of the prescribed DCI format field may be referred to as a switching trigger.

Which of the first generation method and the second generation method the HARQ-ACK information of the PDSCH is provided by may be provided based at least on the switching trigger in the first DCI format scheduling the PDSCH. The first DCI format may be any of the DCI format 1_0 and the DCI format 1_1.

Which of the first generation method and the second generation method the transmission of the HARQ-ACK information of the PDSCH is provided by may be triggered by the switching trigger in the second DCI format. The second DCI format may be different from the first DCI format scheduling the PDSCH. The second DCI format may be a DCI format used to determine which of the first generation method and the second generation method the transmission of the HARQ-ACK information of the PDSCH is provided by. The second DCI format may be a dedicated DCI format to determine which of the first generation method and the second generation method the transmission of the HARQ-ACK information of the PDSCH is provided by. The second DCI format may be a DCI format scheduling a PDSCH before the PDSCH scheduled by the first DCI format.

The second DCI format may not schedule the PDSCH. In other words, the second DCI format may not schedule the PDSCH although the second DCI format indicates a PUCCH resource used to transmit the HARQ-ACK information. The field included in the second DCI format may include the same field as the field included in the first DCI format. The size of the second DCI format may be equal to the size of the first DCI format.

The value of the PDSCH to HARQ feedback timing indicator field included in the second DCI format may indicate a difference (offset) from the slot to which the PDCCH including the second DCI format is mapped to the slot to which at least the head OFDM symbol of the PUCCH resource indicated by the second DCI format is mapped.

The value of the DCI format specification field included in the second DCI format may be set to indicate that the second DCI format is a downlink DCI format.

The value of the DCI format specification field included in the second DCI format may be set to indicate that the second DCI format is an uplink DCI format.

A bit of the frequency domain resource assignment field included in the second DCI format may be set to a prescribed value. For example, setting the bit to the prescribed value may mean that all the bits of the frequency domain resource assignment field are set to 0. Further, setting the bit to the prescribed value may mean that all the bits of the frequency domain resource assignment field are set to 1.

A bit of the time domain resource assignment field included in the second DCI format may be set to a prescribed value. For example, setting the bit to the prescribed value may mean that all the bits of the time domain resource assignment field are set to 0. Also, setting the bit to the prescribed value may mean that all the bits of the time domain resource assignment field are set to 1.

A bit of the MCS field included in the second DCI format may be set to a prescribed value. For example, setting the bit to the prescribed value may mean that all the bits of the MCS field are set to 0. In addition, setting the bit to the prescribed value may mean that all the bits of the MCS field are set to 1.

In generation of the HARQ-ACK information codebook, the transmission of which is indicated based at least on the second DCI format, a set of K1 for the second DCI format may be used. The set of K1 for the second DCI format may be configured by a higher layer parameter. The set of K1 for the second DCI format may be different from the set of K1 for the first DCI format. The set of K1 for the first DCI format may be used at least for the HARQ-ACK information codebook generated by the first generation method.

The field included in the second DCI format may be used at least to indicate the set of K1 for the second DCI format. The set of K1 for the second DCI format may be used to generate the HARQ-ACK information codebook, the transmission of which is indicated based at least on the second DCI format. In the terminal apparatus 1, a plurality of sets of K1 for the second DCI format may be configured.

The sets of K1 may be provided based at least on a transmission time interval of the HARQ-ACK information. The sets of K1 may be provided for each configuration of the transmission time interval of the HARQ-ACK information. The transmission time interval of the HARQ-ACK information may be an interval at which different HARQ-ACK information can be transmitted. The transmission time interval of the HARQ-ACK information may correspond to a unit of the value of K1. In a case that the transmission time interval of the HARQ-ACK information is one slot, for example, the unit of the value of K1 may be one slot. Also, in a case that the transmission time interval of the HARQ-ACK information is 7 OFDM symbols, the unit of the value of K1 may be 7 OFDM symbols.

A licensed frequency band may be a frequency band exclusively allocated to run a wireless communication network (LTE and NR, for example). An unlicensed frequency band may be a frequency band reserved for an unlicensed communication network (wireless LAN, for example). As licensed operation, wireless communication may be performed exclusively using the licensed frequency band. As unlicensed operation, wireless communication may be performed by coexisting with a different unlicensed communication network and sharing the unlicensed frequency band.

Which of the first generation method and the second generation method the transmission of the HARQ-ACK information is provided by may be selected based at least on a frequency band type of the radio access. Which of the first generation method and the second generation method the transmission of the HARQ-ACK information is provided by may be selected depending on the frequency band type of the radio access. Here, the frequency band type of the radio access may indicate the licensed frequency band or the unlicensed frequency band. In a case that the frequency band of the radio access is the licensed frequency band, for example, the terminal apparatus 1 may transmit the HARQ-ACK information using the first generation method. In a case that the frequency band of the radio access is the unlicensed frequency band, the terminal apparatus 1 may transmit the HARQ-ACK information using the second generation method.

Which of the first generation method and the second generation method the transmission of the HARQ-ACK information is provided by may be selected based at least on the operation type of the radio access. Which of the first generation method and the second generation method the transmission of the HARQ-ACK information is provided by may be selected depending on the operation type of the radio access. Here, the operation type of the radio access may indicate licensed operation or unlicensed operation. In a case that the operation type of the radio access is licensed operation, for example, the terminal apparatus 1 may transmit the HARQ-ACK information using the first generation method. In a case that the operation type of the radio access is unlicensed operation, the terminal apparatus 1 may transmit the HARQ-ACK information using the second generation method.

The switching between the first generation method and the second generation method may be switching between the first HARQ-ACK codebook and the second HARQ-ACK codebook.

Various aspects of apparatuses according to an aspect of the present embodiment will be described below.

(1) In order to achieve the aforementioned object, aspects of the present invention provide the following measures. In other words, a first aspect of the present invention provides a terminal apparatus including a receiver configured to receive a PDCCH and receive a PDSCH scheduled based at least on the PDCCH, and a transmitter configured to select either a first generation method or a second generation method as a method for generating a HARQ-ACK codebook and report (transmit) the HARQ-ACK codebook including HARQ-ACK information corresponding to the PDSCH via a PUCCH or a PUSCH based on a timing indicated by a value set to certain information, in which the HARQ-ACK codebook is a sequence of HARQ-ACK information bits corresponding to one or a plurality of the PDSCHs, the transmitter determines the HARQ-ACK codebook including at least a HARQ-ACK information bit corresponding to the PDSCH, in the HARQ-ACK codebook, as the first generation method, a HARQ-ACK information bit is set to an NACK, the HARQ-ACK information bit corresponding to a PDSCH that is not associated with the HARQ-ACK codebook according to a HARQ-ACK timing based on the certain information, and, in the HARQ-ACK codebook, as the second generation method, a part or an entirety of a plurality of the HARQ-ACK information bits are set as valid HARQ-ACK information, the plurality of the HARQ-ACK information bits corresponding to the PDSCH that is not associated with the HARQ-ACK codebook according to the HARQ-ACK timing based on the certain information.

(2) A second aspect of the present invention provides a terminal apparatus in which switching between the first generation method and the second generation method may be indicated based at least on a higher layer parameter, a trigger by a DCI, an operation type of a radio access, or a frequency band type of a radio access.

(3) A third aspect of the present invention provides a terminal apparatus in which switching between the first generation method and the second generation method may be indicated based on a prescribed higher layer parameter and/or a prescribed value of a certain higher layer.

(4) A fourth aspect of the present invention provides a terminal apparatus in which switching between the first generation method and the second generation method may be indicated based on the PDCCH and/or a DCI included in a different PDCCH.

(5) A fifth aspect of the present invention provides a terminal apparatus in which switching between the first generation method and the second generation method may be indicated based on an operation type (either a licensed operation or an unlicensed operation) of a radio access.

(6) A sixth aspect of the present invention provides a terminal apparatus in which switching between the first generation method and the second generation method may be indicated based on a frequency band type (either a frequency band to be allocated to a licensed operation or a frequency band to be allocated to an unlicensed operation) of a radio access.

(7) A seventh aspect of the present invention provides a base station apparatus including a transmitter configured to transmit a PDCCH and transmit a PDSCH scheduled based at least on the PDCCH, and a receiver configured to select either a first reception processing method or a second reception processing method as a method for receiving a HARQ-ACK codebook and receive the HARQ-ACK codebook including HARQ-ACK information corresponding to the PDSCH via a PUCCH or a PUSCH based on a timing indicated by a value set to certain information, in which the HARQ-ACK codebook is a sequence of HARQ-ACK information bits corresponding to one or a plurality of the PDSCHs, in the HARQ-ACK codebook, as the first reception processing method, a HARQ-ACK information bit is set to an NACK, the HARQ-ACK information bit corresponding to a PDSCH that is not associated with the HARQ-ACK codebook according to a HARQ-ACK timing based on the certain information, and, in the HARQ-ACK codebook, as the second reception processing method, a part or an entirety of a plurality of the HARQ-ACK information bits are set as valid HARQ-ACK information, the plurality of the HARQ-ACK information bits corresponding to the PDSCH that is not associated with the HARQ-ACK codebook according to the HARQ-ACK timing based on the certain information.

Each of the program running on a base station apparatus 3 and a terminal apparatus 1 according to the present invention may be a program (a program that causes a computer to function) that controls a Central Processing Unit (CPU) and the like, in such a manner as to implement the functions of the aforementioned embodiment according to the present invention. Also, the information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the aforementioned embodiment may be partially implemented by a computer. In such a case, a program for implementing such control functions may be recorded on a computer-readable recording medium to cause a computer system to read and execute the program recorded on this recording medium.

Note that it is assumed that the “computer system” mentioned here refers to a computer system built into the terminal apparatus 1 or the base station apparatus 3, and the computer system includes an OS and hardware components such as a peripheral device. Furthermore, the “computer-readable recording medium” refers to a portable medium such as a flexible disk, a magneto-optical disk, a ROM, a CD-ROM, and a storage device such as a hard disk built into the computer system.

Moreover, the “computer-readable recording medium” may include a medium that dynamically retains the program for a short period of time, such as a communication wire that is used to transmit the program over a network such as the Internet or over a communication line such as a telephone line, and a medium that retains the program for a certain period of time, such as a volatile memory within the computer system which functions as a server or a client in a case that the program is transmitted via the communication wire. Furthermore, the aforementioned program may be configured to implement part of the functions described above, and also may be configured to be capable of implementing the functions described above in combination with a program already recorded in the computer system.

Furthermore, the base station apparatus 3 according to the aforementioned embodiment may be achieved as an aggregation (apparatus group) including a plurality of apparatuses. Each of the apparatuses included in such an apparatus group may include each function, or some or all portions of each functional block of the base station apparatus 3 according to the aforementioned embodiment. As the apparatus group, it is only necessary to have a complete set of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have some or all of the functions of a higher node for an eNodeB and/or a gNB.

Also, some or all portions of each of the terminal apparatus 1 and the base station apparatus 3 according to the aforementioned embodiment may be implemented as an LSI which is a typical integrated circuit or may be implemented as a chip set. The functional blocks of each of the terminal apparatus 1 and the base station apparatus 3 may be individually implemented as a chip, or some or all of the functional blocks may be integrated into a chip. A circuit integration technique is not limited to the LSI, and may be implemented with a dedicated circuit or a general-purpose processor. Moreover, in a case that with advances in semiconductor technology, a circuit integration technology with which an LSI is replaced appears, it is also possible to use an integrated circuit based on the technology.

In addition, although the aforementioned embodiments have described the terminal apparatus as an example of a communication apparatus, the present invention is not limited to such a terminal apparatus, and is applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope not depart from the gist of the present invention. Furthermore, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

1. A terminal apparatus comprising:
a receiver configured to receive a PDCCH and receive a PDSCH scheduled based at least on the PDCCH,
wherein either a first generation method or a second generation method is selected as a method for generating a HARQ-ACK codebook,
in the HARQ-ACK codebook, as the first generation method, a HARQ-ACK information bit is set to an NACK, the HARQ-ACK information bit corresponding to a PDSCH that is not associated with the HARQ-ACK codebook according to a HARQ-ACK timing based on the certain information, and
the second generation method is different from the first generation method.

2. The terminal apparatus according to claim 1, wherein
in the HARQ-ACK codebook, as the second generation method, a part or an entirety of a plurality of the HARQ-ACK information bits are set as valid HARQ-ACK information, the plurality of the HARQ-ACK information bits corresponding to the PDSCH that is not associated with the HARQ-ACK codebook according to the HARQ-ACK timing based on the certain information.

3. The terminal apparatus according to claim 1, wherein
switching between the first generation method and the second generation method is indicated based at least on a higher layer parameter, a trigger by a DCI, an operation type of a radio access, or a frequency band type of a radio access.

4. The terminal apparatus according to claim 1, wherein
switching between the first generation method and the second generation method is indicated based on a prescribed higher layer parameter and/or a prescribed value of a certain higher layer.

5. The terminal apparatus according to claim 1, wherein
switching between the first generation method and the second generation method is indicated based on the PDCCH and/or a DCI included in a different PDCCH.

6. The terminal apparatus according to claim 1, wherein
switching between the first generation method and the second generation method is indicated based on an operation type (either a licensed operation or an unlicensed operation) of a radio access.

7. The terminal apparatus according to claim 1, wherein
switching between the first generation method and the second generation method is indicated based on a frequency band type (either a frequency band to be allocated to a licensed operation or a frequency band to be allocated to an unlicensed operation) of a radio access.

8. A base station apparatus comprising:
a transmitter configured to transmit a PDCCH and transmit a PDSCH scheduled based at least on the PDCCH,
wherein either a first reception processing method or a second reception processing method is selected as a method for receiving a HARQ-ACK codebook,
in the HARQ-ACK codebook, as the first reception processing method, a HARQ-ACK information bit is set to an NACK, the HARQ-ACK information bit corresponding to a PDSCH that is not associated with the HARQ-ACK codebook according to a HARQ-ACK timing based on the certain information, and
in the HARQ-ACK codebook, as the second reception processing method, a part or an entirety of a plurality of the HARQ-ACK information bits are set as valid HARQ-ACK information, the plurality of the HARQ-ACK information bits corresponding to the PDSCH that is not associated with the HARQ-ACK codebook according to the HARQ-ACK timing based on the certain information.

9. A communication method used by a terminal apparatus, the method comprising the steps of:
receiving a PDCCH and receiving a PDSCH scheduled based at least on the PDCCH;
selecting either a first generation method or a second generation method as a method for generating a HARQ-ACK codebook;
reporting (transmitting) the HARQ-ACK codebook including HARQ-ACK information corresponding to the PDSCH via a PUCCH or a PUSCH based on a timing indicated by a value set to certain information,
the HARQ-ACK codebook being a sequence of HARQ-ACK information bits corresponding to one or a plurality of the PDSCHs;
determining the HARQ-ACK codebook including at least a HARQ-ACK information bit corresponding to the PDSCH;
setting, in the HARQ-ACK codebook, as the first generation method, a HARQ-ACK information bit to an NACK, the HARQ-ACK information bit corresponding to a PDSCH that is not associated with the HARQ-ACK codebook according to a HARQ-ACK timing based on the certain information; and
setting, in the HARQ-ACK codebook, as the second generation method, a part or an entirety of a plurality of the HARQ-ACK information bits as valid HARQ-ACK information, the plurality of the HARQ-ACK information bits corresponding to the PDSCH that is not associated with the HARQ-ACK codebook according to the HARQ-ACK timing based on the certain information.

10. A communication method used by a base station apparatus, the method comprising the steps of:
transmitting a PDCCH and transmitting a PDSCH scheduled based at least on the PDCCH;
selecting either a first reception processing method or a second reception processing method as a method for receiving a HARQ-ACK codebook;
receiving the HARQ-ACK codebook including HARQ-ACK information corresponding to the PDSCH via a PUCCH or a PUSCH based on a timing indicated by a value set to certain information,
the HARQ-ACK codebook being a sequence of HARQ-ACK information bits corresponding to one or a plurality of the PDSCHs;
setting, in the HARQ-ACK codebook, as the first reception processing method, a HARQ-ACK information bit to an NACK, the HARQ-ACK information bit corresponding to a PDSCH that is not associated with the HARQ-ACK codebook according to a HARQ-ACK timing based on the certain information; and
setting, in the HARQ-ACK codebook, as the second reception processing method, a part or an entirety of a plurality of the HARQ-ACK information bits as valid HARQ-ACK information, the plurality of the HARQ-ACK information bits corresponding to the PDSCH that is not associated with the HARQ-ACK codebook according to the HARQ-ACK timing based on the certain information.
